(19) United States
(12) Patent Application Publication
(10) Pub. No.: US 2002/0066322 A1
(43) Pub. Date: Jun. 6, 2002

(54) Device for producing a predeterminable volume of precleaned components of solution mixtures

(76) Inventor: Michael Baumann, Dorfen (DE)

Correspondence Address: JACOBSON HOLMAN, PROFESSIONAL LIMITED LIABILITY COMPANY, 400 SEVENTH STREET, N.W., WASHINGTON, DC, 20004, US

(21) Appl. No.: 10/001,965

(22) Filed: Dec. 5, 2001

(30) Foreign Application Priority Data
Dec. 5, 2000 (DE) 200 20 555.2

(51) Int. Cl. G01N 1/14

(52) U.S. Cl. 73/864.34; 73/863.23

(57) ABSTRACT

The invention relates to a device for producing a predeterminable volume of components of solution mixtures with a metering device for the solution mixture, a separator that is downstream of said metering device and is intended to separate out undesired components contained in the solution mixture, and a vacuum unit for evaporating the solution mixture, which is precleaned in the separator, to the predetermined volume, whereby a conveyor having a predeterminable rate of flow is upstream of the separator and a device for preventing the flow rate of the conveyor from being affected by the vacuum present in the vacuum unit is upstream of the vacuum unit.

The invention relates to a device for producing a predeterminable volume of components of solution mixtures with a metering device for the solution mixture, a separator that is downstream of said metering device and is intended to separate out undesired components contained in the solution mixture, and a vacuum unit for evaporating the solution mixture, which is precleaned in the separator, to the predetermined volume.

To determine the total content of soluble components in a solution mixture, one uses a process, in which a specified residual volume of the components, contained in a predetermined quantity of the solution mixture, is produced by evaporation in order to feed this residual volume to a chemical analysis, where not only the type of individual components but also their numerical quantity ratio can be determined.

However, the initial solution mixture usually contains, besides the components to be analyzed, also other undesired components. Therefore, it is necessary to separate off these undesired components before the evaporation process. To this end, it is customary to use a liquid chromatographic column, through which the solution mixtures passes. Then the undesired components contained in the solution mixture are separated owing to the different chemical and physical properties of the substances in their interaction with the material contained in the chromatographic column. For optimal separation of the substances, it is necessary that the rate of flow that is already fixed by standards be constant in the chromatographic column. In addition, it is absolutely mandatory that a socalled “dry run” of the chromatographic column must be avoided, because it would result in the initiation of cracks in the gel of the chromatographic column, the consequence of which would be a drastically reduced and totally undefined interaction between the solution mixture and the material contained in the chromatographic column.

To maintain a uniform rate of flow in the chromatographic column, the solution mixture is passed together with a carrier liquid, which is pumped in, through the chromatographic column, whereby the carrier liquid is pressed under the adjustable, but constant pumping effect together with the predetermined quantity of solution mixture through the chromatographic column. Behind the chromatographic column, the undesired components, for example greases, contained in the solution mixture, are collected within a first timespan and discarded. The components that follow in chronological sequence and are as a rule pesticides, whose content is supposed to be determined in the solution mixture, are collected and filled into the evaporator, so that upon completed evaporation to a predeterminable residual volume, said residual volume is fed to chemical analysis.

According to experience, this separating process in the chromatographic column lasts until the undesired components have settled out—approx. 20 minutes. Then the phase begins, in which the solution mixture to be analyzed follows. This phase usually takes about 30 minutes. Not until completion of the time-consuming cleaning process, can one start to fill the evaporation vessel, heat the vessel and produce a vacuum to accelerate the evaporation process. Experience has shown that this process takes another 30 to 45 minutes.

The main object of this invention is to decrease the time for the entire operation. An additional object of this invention is to simplify the procedural steps without having to accept cumbersome execution of the process.

The invention solves this problem in that a conveyor having a predeterminable rate of flow is upstream of the separator, and a device for preventing the flow rate of the conveyor from being affected by the vacuum present in the vacuum unit is upstream of the vacuum unit.

Hence, the goal is reached that the solution mixture's rate of flow through the chromatographic column remains at its predeterminable value, which can be optimally adjusted, without the vacuum present in the evaporator having an effect on the solution mixture's rate of flow in the chromatographic column. The result is the special advantage that the evaporation process can run parallel to the separating process in the chromatographic column, and in particular at the same time. However, it means in other words that not only are the procedural operations simplified but above all the total time, required to produce the residual volume of the components that are present in the solution and are to be identified by analysis, is significantly decreased. In other words, the special advantage of this inventive process is that the separating process occurs simultaneously with the evaporating process, a procedure that may be called in general an on-line process.

This procedure has been especially successful when preferably the devices and measures disclosed in the dependent claims are employed to carry out the process.

Details of the invention are described below in the embodiments with reference to the drawing.

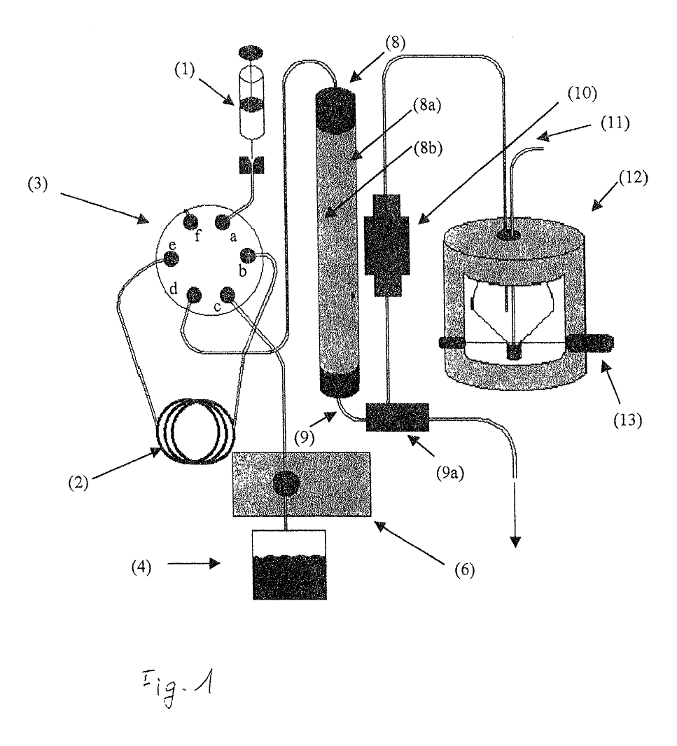

FIG. 1 is a schematic drawing of the construction of the device, according to the invention, and

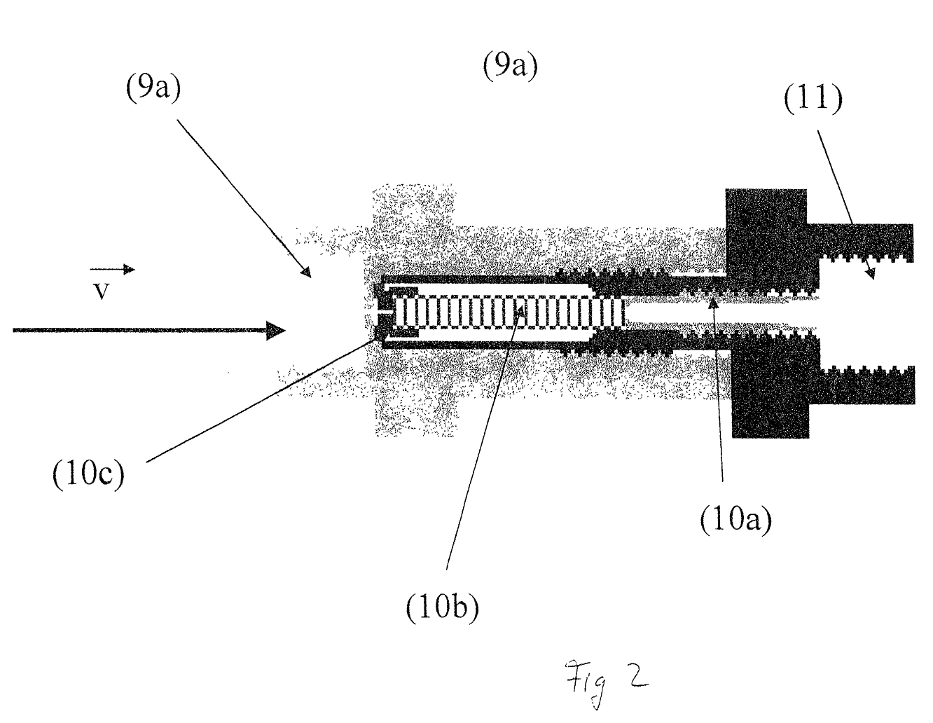

FIG. 2 is a longitudinal view of a back pressure regulating valve.

With the aid of a system to transport liquid, here a robot with attached injection pump 1, the sample to be analyzed is fed by means of a two position six way valve 3 a, b, c, d, e, f to a metering device in the form of a measurement loop 2. In this metering device 2 in the valve position 3 a, f there is a defined overfilling of a measured inert hose 2 with overrun 3a, f into a disposal container, which is not illustrated. In valve position 3 a, f the measured sample quantity (for example, 5 ml) is passed through the chromatographic separation column 8 at a constant flow rate, produced with the mobile solvent 5 by means of a mobile solvent reservoir 4 using a liquid pump 6.

The chromatographic column 8 is made of a glass or metal tube 8a, which is filled with a separating material, for example a gel 8b. The chromatographic column 8 serves to free the solution mixture of components, for example greases, so that in fact only the substances to be analyzed are fed to the subsequent evaporating process. Since the molecules of the greases are larger than those of the pesticides to be analyzed, their interaction with the separating agent 8b in the chromatographic column 8 is also less than that of the pesticides. According to experience, the greases drain off in a starting phase of approx. 20 minutes. They are discarded during this starting phase by way of a valve 9a, sitting in the output line 9 of the chromatographic column 8. The pesticides, which are to be analyzed, are still in the mobile solvent 5, and are to be fed to the evaporator, follow within a subsequent timespan of approximately 20 to 30 minutes.

A back pressure regulator 10 lies downstream in the output line 9. This back pressure regulator 10 is a conventional device for uncoupling various pressure levels.

The back pressure regulator 10 has the shape of a cylindrical sleeve, which exhibits a tight fit on the one side and through which the liquid can flow. A sealing element 10c is pressed against the input opening of the back pressure regulator 10 by means of a helical spring 10b, loaded by means of a setscrew 10a. As a function of the pressure, which can be set by means of the setscrew 10a, on the sealing element 10c, an ideal coupling between a vacuum and the flow process in the chromatographic column can be obtained.

A line 11 leads from the back pressure regulator 10 directly into a heatable vacuum container 12, which serves to concentrate the sample liquid, which has a volume ranging from approximately 80 to 200 ml, to approximately 5 ml. This volume of 5 ml is the reference volume, which is equivalent to the 5 ml of the sample filling for an injection. This reference volume or in other words this end volume is found using an optical method 13. Finally the sample is siphoned off from the vacuum container 12 and can be fed to a chemical analysis.

This procedure makes it possible to carry out simultaneously the flow process and the vacuum concentration of the sample in an ideal manner.

It has become possible with the device of the invention to reduce drastically the time for the chromatographic process, since the cleaning of the sample can run in parallel, thus simultaneously or in other words, in an on-line process with the process of concentration in the vacuum unit; and no other intermediate manual steps by an operator are necessary any more.

1. Device for producing a predeterminable volume of components of solution mixtures with a metering device for the solution mixture, a separator that is downstream of said metering device and is intended to separate out undesired components contained in the solution mixture, and a vacuum unit for concentrating the solution mixture, which is precleaned in the separator, to the predetermined volume, characterized in that a conveyor (6) having a predeterminable rate of flow is upstream of the separator (8) and a device (10) for preventing the flow rate of the conveyor from being affected by the vacuum present in the vacuum unit is upstream of the vacuum unit (12).

2. Device, as claimed in claim 1, characterized in that the conveyor is a liquid pump (6), which is connected to a liquid reservoir (4) and which adds to the quantity of the solution mixture that is determined by the metering device (2) a carrier liquid (5), which is conveyed together with the solution mixture through the separator (8).

3. Device, as claimed in claim 1 or 2, characterized in that the device for preventing an effect on the flow rate is a valve (10).

4. Device, as claimed in any one of the preceding claims, characterized in that a back pressure regulator (10) is installed as the valve.

5. Device, as claimed in any one of the preceding claims, characterized in that the back pressure regulator includes a cylindrical housing, in which a sealing element (10c) can be pressed in the direction of the inflow opening of the housing by means of a helical spring (10b), which can be loaded by means of a setscrew (10a).

6. Device, as claimed in any one of the preceding claims, characterized in that a hose, which has a defined internal volume (measurement loop) and in which the volume of the fed-in solution mixture can be determined, is used as the metering device (2).

7. Device, as claimed in any one of the preceding claims, characterized in that a chromatographic column (8), through which the quantity of the solution mixture that is determined by the metering device (2) is passed through together with the carrier liquid (5), is used as the separator.
